(19) United States
(12) Patent Application Publication
(10) Pub. No.: US 2021/0254575 A1
(43) Pub. Date: Aug. 19, 2021

(54) SYSTEM FOR CONTROLLING THE POWERTRAIN OF A HYBRID VEHICLE WITH MANAGEMENT OF EXCESS PRESSURE IN THE FUEL RAIL

(71) Applicant: VITESCO TECHNOLOGIES GMBH, Hanover (DE)

(72) Inventor: Fabien CONSTANS, TOULOUSE (FR)

(21) Appl. No.: 17/251,585

(22) PCT Filed: Jun. 12, 2019
(86) PCT No.: PCT/EP2019/065304

§ 371 Date: Dec. 11, 2020

(30) Foreign Application Priority Data
Jun. 12, 2018 (FR) 1855120

(51) Int. Cl. F02D 41/38; B60W 10/06; B60W 10/08; B60W 20/15; F02D 41/40

(52) U.S. Cl. CPC F02D 41/3863; B60W 10/06; B60W 10/08; B60W 20/15; F02D 41/40; F02D 41/12; B60W 2710/083; F02D 2200/0602; F02D 2250/24; F02D 2250/31; B60W 2710/0627

(57) ABSTRACT

A system for controlling the powertrain of a hybrid vehicle which includes an internal combustion engine, an electric machine, and an electric accumulator, the system performing the following steps: detecting an overpressure in the injection rail, with respect to a setpoint pressure; injecting into the internal combustion engine a predetermined quantity of fuel corresponding to the volume of fuel to be removed from the injection rail in order to lower the pressure in the injection rail down to the setpoint pressure; and operating the electric machine in generator mode to absorb the torque generated by the injection of the predetermined quantity of fuel into the internal combustion engine.

### CROSS-REFERENCE TO RELATED APPLICATIONS

This application is the U.S. national phase of International Application No. PCT/EP2019/065304 filed Jun. 12, 2019 which designated the U.S. and claims priority to FR 1855120 filed Jun. 12, 2018, the entire contents of each of which are hereby incorporated by reference.

### BACKGROUND OF THE INVENTION

### Field of the Invention

The invention relates to a system for controlling the powertrain of a hybrid vehicle which comprises an internal combustion engine and an electric machine.

### Description of the Related Art

Such a hybrid vehicle is propelled either by its internal combustion engine, or by its electric machine made to operate as a propulsion motor, or by these two elements together.

The electric machine of such a hybrid vehicle is generally able to be operated in two modes: a motor mode in which the electric machine delivers torque to contribute to the propulsion of the vehicle, alone or together with the combustion engine, as indicated hereinabove; and a generator mode in which the electric machine is used to charge an electric accumulator such as a battery pack. When the electric machine is operated in generator mode, it absorbs torque from the transmission elements of the vehicle, for example by slowing the vehicle, and from this torque generates an electrical voltage used to charge the electric accumulator. Conversely, when the electric machine is operated in motor mode, it delivers torque which will be transmitted to the transmission elements in order to propel the vehicle.

As far as the internal combustion engine is concerned, this is generally fitted with injectors associated with a pressurized injection rail. The pressurized injection rail is pressurized to a determined pressure and the opening of the injectors causes fuel to be injected into the internal combustion engine. The burning of the injected fuel within the engine allows the latter to deliver torque to contribute to the propulsion of the vehicle.

A hybrid vehicle therefore notably has two phases of operation:
a propulsion phase during which the internal combustion engine and/or the electric machine, operated in motor mode, deliver torque;
a regeneration phase during which the hybrid vehicle is braked and the electric accumulator is recharged using the electrical current produced by the electric machine operated in generator mode which absorbs torque.

Under certain conditions, the hybrid vehicle regeneration phases prove to be insufficient for satisfactorily recharging the electric accumulator.

Certain hybrid vehicles are also equipped with an electric terminal allowing the hybrid vehicle to be connected to an electricity network. Additional charging of the electric accumulator can therefore take place when the vehicle is parked, by means of an electric vehicle recharging point or a domestic electrical outlet. This additional charging phase can, however, take place only when the vehicle is stopped.

### SUMMARY OF THE INVENTION

It is an object of the invention to improve the hybrid vehicles of the prior art by allowing better management of the charging of the electric accumulator.

To this end, the invention relates to a system for controlling the powertrain of a hybrid vehicle which comprises an internal combustion engine, an electric machine, and an electric accumulator, the system being designed to:
inject fuel into the internal combustion engine using a pressurized injection rail so that the internal combustion engine delivers torque which contributes to the propulsion of the hybrid vehicle;
operate the electric machine in one of the following modes: a motor mode in which the electric machine is electrically powered by the electric accumulator and delivers torque which contributes to the propulsion of the hybrid vehicle; and a generator mode in which the electric machine absorbs torque and charges the electric accumulator.

The system performs the following steps according to the invention:
detecting an overpressure in the injection rail, with respect to a setpoint pressure;
injecting into the internal combustion engine a predetermined quantity of fuel corresponding to the volume of fuel to be removed from the injection rail in order to lower the pressure in the injection rail down to the setpoint pressure;
operating the electric machine in generator mode to absorb the torque generated by the injection of the predetermined quantity of fuel into the internal combustion engine.

The invention can be applied to any type of hybrid vehicle, whatever the power of its electric machine and whatever its type of coupling with the internal combustion engine, provided that the electric machine can be operated in generator mode.

The invention makes it possible to increase the overall charge time of the electric accumulator, by profiting from the phases of propulsion of the vehicle to contribute to charging. In addition to the charging sequences which occur during the regeneration phases, the electric accumulator is also charged during certain regions of the propulsion phases, when the internal combustion engine is active and requires the pressure in its injection rail to be lowered.

The increase in the regions of recharging of the electric accumulator ensures that the latter will benefit from a higher average charge than the hybrid vehicles of the prior art. The invention is particularly advantageous for hybrid vehicles that do not have a connection terminal allowing the accumulator to be charged when the hybrid vehicle is parked, or when the hybrid vehicle, although equipped with such charging terminals, does not have access to the electricity network, or else when the driving conditions under which the hybrid vehicle is operated mean that regeneration phases are rare (for example if it is driven on main roads with very few deceleration and braking phases). The invention is therefore particularly advantageous in the instances in which the regeneration phases and the electricity-network charging phases are minimal. The invention is able to effectively supplement the charging phases.

In addition, the invention makes it possible to simplify the internal combustion engine which then does not require any pressure-reducing device for its injection rail. Specifically, internal combustion engines generally need such pressure-reducing devices in order to be able to control the pressure present in the injection rail. Notably depending on its rotational speed and on the torque demanded of it, an internal combustion engine requires an injection pressure which may vary greatly. For a diesel engine with a high injection pressure, for example, the injection pressure may be around 2500 bar at full load and may be around 200 to 300 bar at light load, for example at low idle. The pressure in the injection rail therefore needs to vary between these two extreme values and the lowering of the pressure in the injection rail is generally achieved by pressure-reducing devices such as controlled backleak devices at the injectors or relief valves situated directly in the injection rail. These devices make it possible to remove a portion of the volume of fuel contained in the pressure rail in order to achieve the necessary reduction in pressure. The invention makes it possible to dispense with any pressure-reducing device by achieving the necessary pressure reductions using fuel-injection phases which, in addition to reducing the pressure in the injection rail, allowed charging of the electric accumulator.

Eliminating the electro-mechanical elements represented by the pressure-reducing devices of the prior art leads to a lowering of the cost of the internal combustion engine, as well as to a simplification thereof, and to an increase in its reliability.

The control system according to the invention may comprise the following additional features, alone or in combination:
the step of detecting an overpressure in the injection rail involves an operation of comparing the setpoint pressure with the pressure measured by a pressure sensor sensing the pressure in the injection rail;
said volume of fuel to be removed from the injection rail is converted into a mass of fuel to be removed from the injection rail in order to determine the predetermined quantity of fuel;
the system performs a step of determining the maximum torque that the electric machine can absorb in generator mode, and of determining the quantity of fuel that produces a torque equal to this maximum torque when it is injected into the internal combustion engine;
the step of injecting the predetermined quantity of fuel into the internal combustion engine is performed after a step of determining a mass of fuel for each injection operation, which is capped by said maximum torque;
the step of injecting the predetermined quantity of fuel into the internal combustion engine is performed by converting the predetermined quantity of fuel into a first torque setpoint to be applied for a predetermined duration;
during the step of injecting the predetermined quantity of fuel into the internal combustion engine, an additional quantity of fuel is injected, corresponding to an initial torque setpoint;
said initial torque setpoint is added to said first torque setpoint in order to obtain a resultant torque setpoint which is applied for said predetermined duration;
the step of operating the electric machine in generator mode, to absorb the torque generated by the injection of the predetermined quantity of fuel, is performed for said predetermined duration.

### BRIEF DESCRIPTION OF THE DRAWINGS

A preferred exemplary embodiment of the invention will now be described with reference to the appended drawings, in which:

FIG. 1 is a schematic depiction of a hybrid vehicle;

FIG. 2 is a diagram of the fuel injection circuit of the internal combustion engine of the vehicle of FIG. 1;

FIG. 3 is a diagram illustrating the operation of the control system according to the invention.

### DESCRIPTION OF THE PREFERRED EMBODIMENTS

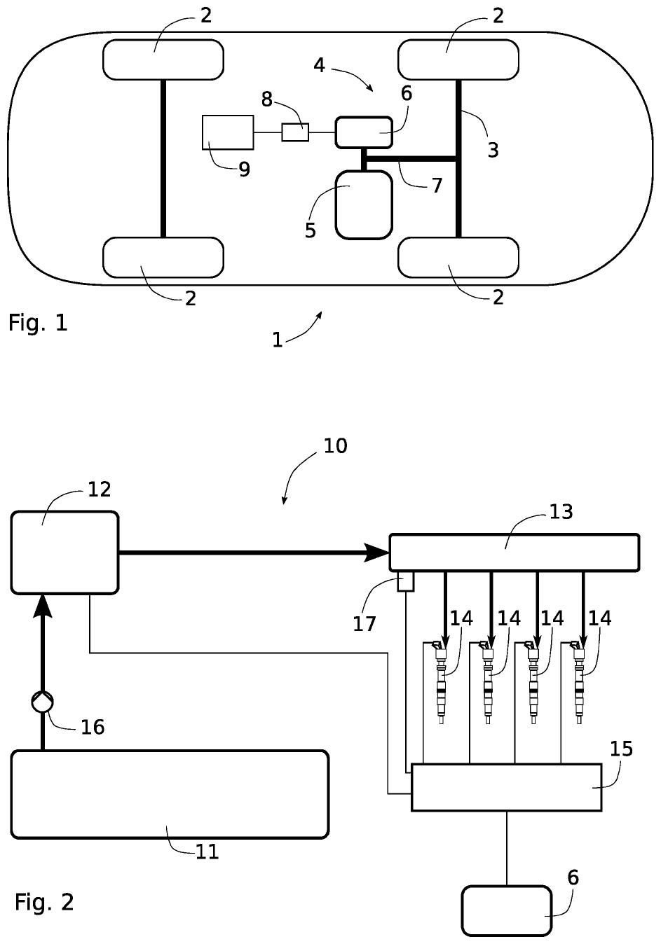

FIG. 1 is a schematic depiction of a hybrid vehicle 1 implementing the invention, viewed from above. This schematic view shows the various elements to which the invention relates.

The hybrid vehicle 1 comprises four wheels 2 distributed across two axles 3. A powertrain 4 is associated, in this example, with one of the axles 3. This powertrain 4 comprises an internal combustion engine 5 and an electric machine 6 which are connected to the corresponding axle 3 by a transmission 7.

The internal combustion engine 5 and the electric machine 6 (operated in motor mode) are able to propel, jointly or separately, the vehicle 1 via the transmission 7 which drives the rotation of the wheels 2.

The internal combustion engine 5 is an engine equipped with an injection device allowing it to be supplied with fuel, so that the combustion of this fuel allows the internal combustion engine 5 to supply mechanical energy to turn the wheels 2.

The electric machine 6 for its part is electrically connected to a reversible charger and inverter device 8, which is itself electrically connected to an electric accumulator 9.

The electric accumulator 9 may be any device able to store electrical energy. In this example, it is a pack of lithium-ion batteries which are commonplace in the field of hybrid vehicles. The inverter-charger device 8 is an electronic device generally equipped with a power transistor and able, on the one hand, starting from a current supplied by the electric machine 6, to charge the electric accumulator 9 and, on the other hand, starting from a current supplied by the electric accumulator 9, to power the electric machine 6. The electric machine 6 can thus be operated in two modes:
a motor mode in which it is electrically powered by the electric accumulator 9, via the device 8 operating as an inverter, to deliver torque and contribute to the propulsion of the vehicle via the transmission 7; and
a generator mode in which the electric machine 6 is this time driven in rotation by the transmission 7 so as to produce current and thus charge the electric accumulator 9 via the device 8 operating as a charger.

In a manner conventional for a hybrid vehicle, the vehicle 1 may operate in at least two phases:
a propulsion phase in which the powertrain 4 transmits power to the wheels 2. In this phase, the vehicle 1 is powered either by the internal combustion engine 5 alone, or by the electric machine 6 alone, operated in motor mode, or by the internal combustion engine 5 and the electric machine 6 operated in motor mode, both combined;
a regeneration phase in which the wheels 2 transmit power to the powertrain 4 (for example when running downhill or during a phase of deliberate deceleration), this power generating torque that the transmission 7 transmits to the electric machine 6 alone. The electric machine 6 is then operated in generator mode and, by absorbing torque, delivers current for charging the accumulator 9.

The hybrid vehicle 1 thus consumes energy coming from the fuel supplied to the internal combustion engine 5, or electrical energy accumulated in the electric accumulator 9 in order to deliver torque via the transmission 7, or, on the other hand, absorbs torque transmitted by the transmission 7 in order to charge the electric accumulator 9.

According to a variant which has not been depicted, the charger/inverter device 8 comprises an external-connection connector allowing for electrical connection to an external electricity network for top-up charging of the electric accumulator 9.

FIG. 2 schematically depicts the injection system of the internal combustion engine 5 with which the hybrid vehicle 1 of FIG. 1 is equipped.

In this example, the internal combustion engine 5 is a four-cylinder diesel engine. The injection system 10 comprises a fuel tank 11, an injection pump 12, an injection rail 13, four injectors 14 corresponding to the four cylinders of the engine, and an engine control unit 15.

The fuel from the fuel tank 11 is supplied to the injection pump 12 by a fuel pump 16. The injection pump 12 pressurizes the fuel in the injection rail 13. The injectors 14 are in fluidic communication with the injection rail 13 and are controlled by the engine control unit 15 so that the engine control unit 15 is able to open each injector 14 so that it performs an injection sequence at the pressure prevailing in the injection rail 13.

The engine control unit 15 is additionally connected to a pressure sensor 17 which measures the pressure prevailing in the injection rail 13. The engine control unit 15 is also connected to the injection pump 12 in order to control same. The engine control unit 15 is thus able to measure the pressure prevailing in the injection rail 13 and vary this pressure by controlling the injection pump 12.

The engine control unit 15 is furthermore connected, directly or indirectly, to the electric machine 6.

The engine control unit 15 may of course comprise additional connections for known devices conventionally used in motor vehicles, for example connections to sensors for camshafts, various temperatures, etc., or connections to other actuators. In FIG. 2 only the elements necessary for understanding the invention have been depicted.

In this example, the internal combustion engine 5 is a high-injection-pressure engine for which the pressures required for injection are, for example, 2500 bar at full load, and of the order of 200 to 300 bar at low idle. Thus, when the load on the engine 5 increases, the engine control unit 15 determines a setpoint pressure for the target engine operating point. The engine control unit then detects, using the pressure sensor 17, that the pressure in the injection rail 13 needs to be increased, and controls the injection pump 12 accordingly. Conversely, when the load decreases, for example when the driver lifts his foot off the throttle pedal, the engine control unit 15 determines a new setpoint value for the injection pressure and controls the injectors 14 accordingly in order to achieve the necessary drop in pressure in the injection rail 13 and at the same time perform a phase of charging the electric accumulator 9 via the electric machine 6 operated in generator mode.

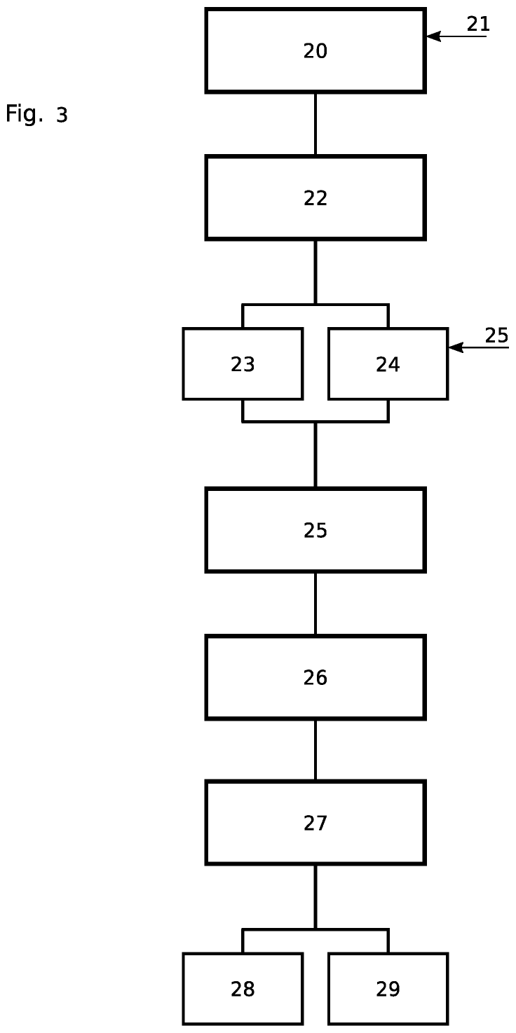

FIG. 3 illustrates in detail the operation of the system performed by the engine control unit 15 when a lowering of the pressure in the injection rail 13 is needed.

FIG. 3 is a diagram illustrating the operation of the system for controlling the powertrain 4 according to the invention. When a lowering of the pressure in the injection rail 13 is needed, the engine control unit 15 profits from this pressure-lowering operation performed by the injectors 14 to carry out an operation of charging the accumulator 9.

The engine control unit also controls the internal combustion engine 5 in the conventional way using known engine maps wherein to each engine operating point there corresponds a setpoint pressure in the injection rail 13, which itself corresponds to the injection pressure that is to be obtained at the injectors 14 for this engine operating point. The engine control unit 15 controls the injection pump 12 accordingly in order to conform to this setpoint pressure.

The system begins with detecting the need to lower the pressure in the injection rail 13. Thus, during a first step 20, the engine control unit 15 compares the setpoint pressure for the injection rail 13 with the measurement of the actual pressure prevailing in the injection rail 13, given by the pressure sensor 17. Receipt of the pressure measured by the sensor 17 is indicated schematically by the arrow 21 in FIG. 3. When, in this step 20, the engine control unit 15 establishes that the difference between the actual pressure in the injection rail 13 and the setpoint pressure (for a target engine operating point) is above a threshold, the detection of a need to lower the pressure in the injection rail 13 is made. In step 20, the engine control unit 15 calculates the difference in pressure between the actual pressure measured in the injection rail 13 and the setpoint pressure, namely the magnitude of the desired drop in pressure in the injection rail 13.

When a need to lower the pressure in the injection rail 13 is detected in step 20, the system passes on to a step 22 during which the engine control unit 15 calculates the volume of fuel that needs to be extracted from the injection rail 13 in order for the latter to reach the setpoint pressure. The engine control unit 15 for this, in the known way, uses the elastic modulus of the fuel in order to deduce therefrom this volume that is to be extracted, this being dependent on the pressure and on the temperature. The volume determined in step 22 corresponds to the volume of fuel that will need to be injected into the internal combustion engine 5 using the injectors 14 for the purposes of bringing the injection rail 13 to the setpoint pressure.

The system then passes on to steps 23 and 24 which may be performed independently of one another.

In step 23, the engine control unit 15 converts the volume of fuel to be injected, which was determined in step 22, into a mass of fuel to be injected. The engine control unit 15 for this uses a table of the density of the fuel for a given pressure and temperature.

In step 24, the engine control unit 15, which is connected to the electric machine 6, receives from the latter an item of information 25 relating to the maximum torque that the electric machine 6 is able to absorb when it is operated in generator mode. Specifically, depending on its power, the electric machine 6 is characterized by a maximum torque value that it is able to convert into electrical current. In step 24, the engine control unit 15, on the basis of this item of information 25, converts this maximum torque value into a value for the maximum mass of fuel to be injected by an injector 14 in each injection operation. More specifically, during this step 24, the engine control unit 15 determines the quantity of fuel to be injected into the internal combustion engine 5 so that the latter reaches the maximum torque given by the item of information 25. In addition, when the internal combustion engine 5 is running, a certain number of injection operations take place into the cylinders of this engine, each injector 14 proceeding with an injection operation (which comprises one or more jets of fuel injected into the corresponding cylinder). Step 24 therefore makes it possible to determine the maximum quantity to be injected for each injection operation of each injector 14, and such that the internal combustion engine 5 supplies the maximum torque corresponding to the item of information 25 received. In a variant, the item of information 25 is stored in memory in the engine control unit 15 rather than being received from the electric machine 6.

After step 23 and step 24, the engine control unit 15 therefore has available to it the mass of fuel that it needs to inject in order to achieve the desired reduction in pressure in the injection rail 13, and has available to it the maximum mass that it needs to inject in each operation of an injector 14 so that the electric machine 6 is capable of absorbing the torque produced by these injection operations, namely so that it is capable of converting this torque into electrical energy intended for charging the electric accumulator 9.

The system next passes on to step 25 during which the engine control unit 15 calculates the mass of fuel to be injected in each operation of each injector 14 and the number of injection operations needed. Specifically, if the total mass to be injected (determined in step 23) is greater than the maximum mass of fuel per injection operation, determined in step 24 (which generally is the case), that means that several injection operations will be needed in order to complete the injecting of the mass of fuel determined in step 23, each of these injection operations being capped at the maximum value determined in step 24. In practice, for a conventional internal combustion engine 5, it will generally be necessary to perform several hundred injection operations in order to achieve a significant lowering of the pressure in the injection rail 13. Step 25 therefore allows the engine control unit 15 to determine this number of injection operations needed, and the mass of fuel to be injected in each of these injection operations (this mass of fuel to be injected being capped by the characteristics of the electric machine 6).

The system then moves on to a step 26 during which the engine control unit 15 converts these values from step 25 into a value of the torque to be supplied by the internal combustion engine 5 and a predetermined duration (hereinafter referred to as “duration D”) during which this torque will need to be supplied. The engine maps available in the engine control unit 15 are effectively able to determine:
the torque referred to as “discharge torque CD” which, if given as a setpoint to the engine 5, leads to the injection of the quantity of fuel determined in step 25, for each injection operation;
the duration D for which this discharge torque CD will need to be given as a setpoint to the engine 5 in order for the number of injection operations determined in step 25 to be achieved.

In other words, step 26 determines the discharge torque CD that corresponds to the torque that needs to be given to the engine 5 as a setpoint for the duration D in order to result in the injection of the entire mass of fuel determined in step 23, namely the entire mass of fuel that needs to be extracted from the injection rail 13 in order for this rail to reach the setpoint pressure.

In the next step 27, the engine control unit 15 determines a resultant torque (hereinafter referred to as “resultant torque CR”) by adding together the torque determined in step 26 and the torque given as a setpoint to the engine 5 for the current engine operating point (hereinafter referred to as “initial torque CI”). Specifically, the internal combustion engine 5 is currently in operation and it is possible that, during implementation of the steps described, and independently of those steps, a torque CI is demanded of the internal combustion engine 5, for example through the action of the driver. In that case, the internal combustion engine 5 needs to supply this torque CI required for the propulsion of the hybrid vehicle 1, and needs to supply, in addition, according to the invention, the torque required for lowering the pressure in the injection rail 13, the latter torque being supplied for the duration D. During step 27, the engine control unit 15 therefore proceeds to add together these two torque values and thus determines the total torque that the internal combustion engine 5 needs to supply for the duration D. Beyond the duration D, the torque setpoint for the engine 5 will revert to its initial value CI corresponding to the current engine operating point, without being affected by the matter of lowering the pressure in the injection rail 13.

In step 28, the engine control unit 15 sets in place, by way of new setpoint torque given to the engine 5, the resultant torque CR determined in step 27. More specifically, in step 28, the engine control unit 15 will in the conventional way apply its maps to the internal combustion engine 5, but now requesting as torque setpoint the resultant torque CR rather than the initial torque CI, and will do so for the duration D.

The internal combustion engine 5 will therefore be controlled by the engine control unit 15 (injection quantity, injection time, overall engine management) in such a way that for the duration D it supplies the resultant torque CR which is the sum of the initial torque CI, which allows the required propulsion of the vehicle, and of the discharge torque CD, which allows the desired lowering of the pressure in the injection rail 13.

Note that the torque CI given as a setpoint to the engine 5 may be zero, for example in a deceleration phase in which the driver lifts his foot off the throttle. The resultant torque CR will then be equal to the discharge torque CD and will be given as a setpoint to the engine 5 for the duration D, the torque setpoint for the engine 5 reverting to zero at the end of the duration D.

Simultaneously with step 28, during step 29, the engine control unit 15 issues a negative torque request destined for the electric machine 6, this negative torque corresponding in terms of absolute value to the resultant torque CR. Step 29 consists, insofar as the engine control unit 15 is concerned, in operating the electric machine 6 in generator mode by giving it the value of the resultant torque as the setpoint for torque to be absorbed, this being for the duration D.

Steps 28 and 29 are ongoing for the duration D. During this duration D, the discharge torque CD is produced by the internal combustion engine 5 (in addition to the initial torque CI, if any) and is simultaneously absorbed by the electric machine 6 operated in generator mode. As far as the driver of the hybrid vehicle 1 is concerned, the discharge torque CD is absorbed simultaneously with its production and this is therefore imperceptible and does not affect the propulsion of the hybrid vehicle 1.

The negative torque request in step 29 leads the electric machine 6 to supply an electrical current which is used by the device 8 acting as a charger to recharge the electric accumulator 9.

The lowering of the pressure in the injection rail 13 is thus achieved in a duration D, by virtue of an operation that allows the electric accumulator 9 to be charged during this duration D, this being in an internal combustion engine 5 that does not have any other system dedicated to achieving reductions in the pressure in the injection rail 13.

Other variant embodiments of the system may be implemented without departing from the scope of the invention. For example, the system can be implemented by a hybrid vehicle 1 comprising any type of internal combustion engine 5 equipped with an injection-rail fuel injection device, for example a direct or indirect injection engine running on any fuel such as gasoline, diesel, liquefied petroleum gas, natural gas or any other fuel.

As far as the electric machine 6 of the hybrid vehicle 1 is concerned, this machine may be of any type suited to absorbing torque produced by the internal combustion engine 5 in order to convert it into electrical energy. It may be an electric machine of respectively low, medium or high power (corresponding respectively to “micro-hybrid”, “mild hybrid” or “full hybrid” vehicles) and may be coupled to the internal combustion engine 5 by any known means, for example by a direct mechanical coupling or by a belt.

The electric accumulator 9 of the present example is a pack of lithium-ion batteries, but the system according to the invention is of course applicable to all types of electric accumulator batteries which can be charged by an electric machine 6, such as lead batteries or capacitors.

1. A system for controlling the powertrain (4) of a hybrid vehicle (1) which comprises an internal combustion engine (5), an electric machine (6), and an electric accumulator (9), the system being designed to:
inject fuel into the internal combustion engine (5) using a pressurized injection rail (13) so that the internal combustion engine (5) delivers torque which contributes to the propulsion of the hybrid vehicle (1);
operate the electric machine (6) in one of the following modes: a motor mode in which the electric machine (6) is electrically powered by the electric accumulator (9) and delivers torque which contributes to the propulsion of the hybrid vehicle (1); and a generator mode in which the electric machine (6) absorbs torque and charges the electric accumulator (9);
the system performing the following steps:
detecting an overpressure in the injection rail (13), with respect to a setpoint pressure;
injecting into the internal combustion engine (5) a predetermined quantity of fuel corresponding to the volume of fuel to be removed from the injection rail (13) in order to lower the pressure in the injection rail (13) down to the setpoint pressure;
operating the electric machine (6) in generator mode to absorb the torque generated by the injection of the predetermined quantity of fuel into the internal combustion engine (5).

2. The system as claimed in claim 1, wherein the step of detecting an overpressure in the injection rail (13) involves an operation of comparing the setpoint pressure with the pressure measured by a pressure sensor (17) sensing the pressure in the injection rail (13).

3. The system as claimed in claim 1, wherein said volume of fuel to be removed from the injection rail (13) is converted into a mass of fuel to be removed from the injection rail (13) in order to determine the predetermined quantity of fuel.

4. The system as claimed in claim 1, wherein the system performs a step of determining the maximum torque that the electric machine (6) can absorb in generator mode, and of determining the quantity of fuel that produces a torque equal to this maximum torque when said quantity of fuel is injected into the internal combustion engine (5).

5. The system as claimed in claim 4, wherein the step of injecting the predetermined quantity of fuel into the internal combustion engine (5) is performed after a step of determining a mass of fuel for each injection operation, which is capped by said maximum torque.

6. The system as claimed in claim 1, wherein the step of injecting the predetermined quantity of fuel into the internal combustion engine (5) is performed by converting the predetermined quantity of fuel into a first torque setpoint to be applied for a predetermined duration.

7. The system as claimed in claim 6, wherein, during the step of injecting the predetermined quantity of fuel into the internal combustion engine (5), an additional quantity of fuel is injected, corresponding to an initial torque setpoint.

8. The system as claimed in claim 7, wherein said initial torque setpoint is added to said first torque setpoint in order to obtain a resultant torque setpoint which is applied for said predetermined duration.

9. The system as claimed in claim 6, wherein the step of operating the electric machine (6) in generator mode, to absorb the torque generated by the injection of the predetermined quantity of fuel, is performed for said predetermined duration.

10. The system as claimed in claim 2, wherein said volume of fuel to be removed from the injection rail (13) is converted into a mass of fuel to be removed from the injection rail (13) in order to determine the predetermined quantity of fuel.

11. The system as claimed in claim 2, wherein the system performs a step of determining the maximum torque that the electric machine (6) can absorb in generator mode, and of determining the quantity of fuel that produces a torque equal to this maximum torque when said quantity of fuel is injected into the internal combustion engine (5).

12. The system as claimed in claim 3, wherein the system performs a step of determining the maximum torque that the electric machine (6) can absorb in generator mode, and of determining the quantity of fuel that produces a torque equal to this maximum torque when said quantity of fuel is injected into the internal combustion engine (5).

13. The system as claimed in claim 2, wherein the step of injecting the predetermined quantity of fuel into the internal combustion engine (5) is performed by converting the predetermined quantity of fuel into a first torque setpoint to be applied for a predetermined duration.

14. The system as claimed in claim 3, wherein the step of injecting the predetermined quantity of fuel into the internal combustion engine (5) is performed by converting the predetermined quantity of fuel into a first torque setpoint to be applied for a predetermined duration.

15. The system as claimed in claim 4, wherein the step of injecting the predetermined quantity of fuel into the internal combustion engine (5) is performed by converting the predetermined quantity of fuel into a first torque setpoint to be applied for a predetermined duration.

16. The system as claimed in claim 5, wherein the step of injecting the predetermined quantity of fuel into the internal combustion engine (5) is performed by converting the predetermined quantity of fuel into a first torque setpoint to be applied for a predetermined duration.

17. The system as claimed in claim 1, wherein, during the step of injecting the predetermined quantity of fuel into the internal combustion engine (5), an additional quantity of fuel is injected, corresponding to an initial torque setpoint.

18. The system as claimed in claim 2, wherein, during the step of injecting the predetermined quantity of fuel into the internal combustion engine (5), an additional quantity of fuel is injected, corresponding to an initial torque setpoint.

19. The system as claimed in claim 3, wherein, during the step of injecting the predetermined quantity of fuel into the internal combustion engine (5), an additional quantity of fuel is injected, corresponding to an initial torque setpoint.

20. The system as claimed in claim 4, wherein, during the step of injecting the predetermined quantity of fuel into the internal combustion engine (5), an additional quantity of fuel is injected, corresponding to an initial torque setpoint.
